(19) United States
(12) Patent Application Publication
(10) Pub. No.: US 2026/0203734 A1
(43) Pub. Date: Jul. 16, 2026

(54) RESOLVING OPEN TRANSACTIONS

(71) Applicant: Intuit Inc., Mountain View, CA (US)

(72) Inventors: Santhosh Kumar H M, Bangalore (IN); Padmaprasad AITHAL, Bangalore (IN); Thatchinamoorthy KALLIPATTI ARUMUGAM, Bangalore (IN); Saikiran Sri THUNUGUNTLA, Bangalore (IN); Niranjana H C, Bangalore (IN); Dharshan Sastry BHADRAVATHI NAGARAJA, Bangalore (IN)

(73) Assignee: Intuit Inc., Mountain View, CA (US)

(21) Appl. No.: 19/026,017

(22) Filed: Jan. 16, 2025

(51) Int. Cl. G06Q 20/10

(52) U.S. Cl. CPC G06Q 20/10

(57) ABSTRACT

Systems and methods for resolving open transactions are disclosed herein. An example method may be performed by one or more processors of a computing system. In some implementations, the method includes obtaining, at a source component, a set of change events, each respective change event including metadata indicating a type of the respective change event and a unique identifier for the respective change event, selectively publishing, at the source component, the change events to a staging queue based on the types and the unique identifiers, selectively generating, at a sink component that extracts the change events from the staging queue, boundaries for transactions associated with the change events based on the types and unique identifiers, and publishing, in a target queue, a bounded list indicating, for each of the transactions, a start boundary for the transaction, the change events associated with the transaction, and an end boundary for the transaction.

### CROSS-REFERENCE TO RELATED APPLICATION

This application is related to U.S. patent application Ser. No. 19/025,979 entitled “TRANSACTION BOUNDARIES AND REPLAY AT SCALE” and filed on Jan. 16, 2025, which is assigned to the assignee hereof. The disclosures of all prior Applications are considered part of and are incorporated by reference in this Patent Application.

### TECHNICAL FIELD

This disclosure relates generally to bounding transactions, and specifically to resolving open transactions during the bounding of transactions.

### DESCRIPTION OF RELATED ART

Modern databases can store vast amounts of data, often reaching gigabytes or terabytes in size. As organizations scale, this data is frequently distributed across multiple database clusters, sometimes spanning dozens of systems. Processing such large datasets requires significant computational resources and time, and managing this data introduces challenges such as data errors, latency issues, and operational failures. These challenges are exacerbated when organizations must meet strict Service Level Agreements (SLAs) concerning data availability and reporting accuracy. Many event-driven systems generate billions of daily changes across distributed tables in multiple source databases. Each transaction can span multiple tables and involve hundreds of thousands of data points, with increasing complexity as the number of users or entities grows into the millions.

A critical challenge in maintaining data freshness in such systems relates to open transactions that have not yet been fully completed and/or bound and may occur when a system failure or network interruption occurs before a transaction can be finalized and/or when a component responsible for bounding events into transactions fails. For instance, when there are low traffic volumes (e.g., at night) on one or more partitions in a distributed system, transactions arriving to one or more partitions may diminish or even cease for a time. Thus, if the system relies on the arrival of new transactions before closing previous transactions, a period of open, unfinalized transactions may occur for those partitions. As a result, downstream reporting users (e.g., that are querying data on these partitions) may receive outdated information, which can lead to a degraded customer experience and faulty decision-making.

Several examples illustrate the scope of these challenges, where sets of related events can be grouped and processed as transactions. As one example, with respect to Massively Multiplayer Online Role-Playing Games (MMORPGs), millions of players generate event transactions, such as movements, actions, and trades. These transactions consist of related events that affect various tables, including player profiles, inventories, and world states. An unresolved open transaction in an MMORPG could prevent a player's trade from completing, thereby leaving both players'inventories in an inconsistent state. As another example, global sensor networks, such as those monitoring environmental data, generate continuous readings of temperature, pressure, and other metrics. These readings can be grouped into transactions based on time intervals or geographic regions, allowing for trend detection and anomaly analysis. An unresolved open transaction in a global sensor network could lead to incomplete or inaccurate climate models, which could be significant when temperature and pressure readings change quickly. As another example, with respect to social media platforms, billions of daily user interactions—such as posts, comments, and shares—can be grouped into transactions associated with individual users or posts. An unresolved open transaction on a social media platform could result in a user's post not appearing in their followers'feeds or a comment failing to be attached to the correct post. As yet another example, businesses process and analyze transactional data to report cash flow, sales, account statements, and invoices. An unresolved open transaction in a business's transactional data system could lead to an inaccurate cash flow report, thereby resulting in a misrepresentation of the company's financial health.

Processing, grouping, and ensuring that event transactions are resolved at scale while adhering to required latency constraints is a significant technical challenge. Large-scale data pipelines must process vast amounts of data efficiently while minimizing errors. Issues such as system failures, data loss, and bugs are common in these environments. When managing stateful, event-driven distributed systems, these challenges are increased further. Data may be distributed across many database clusters, and failures in one component can disrupt the entire system. Indeed, open transactions are a particular problem in distributed systems at scale because a failure in one part of the system can leave transactions open across multiple databases, thereby making it difficult to track and resolve them consistently. Although some systems may implement timeouts to automatically roll back transactions after a certain period, this can lead to data loss if legitimate long-running transactions are prematurely terminated.

Accordingly, there is a need for scalable, efficient methods to resolve open transactions that can ensure timely transaction closure even for large volumes of distributed, event-based transactions while ensuring system reliability and performance.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter described in this disclosure can be implemented as a method for resolving open transactions. An example method is performed by one or more processors of a computing system and can include obtaining, at a source component of the computing system, a set of change events, each respective change event including metadata indicating a type of the respective change event and a unique identifier for the respective change event, selectively publishing, at the source component, the change events to a staging queue of the computing system based on the types and the unique identifiers, selectively generating, at a sink component of the computing system that extracts the selectively published change events from the staging queue, boundaries for transactions associated with the change events based on the types and the unique identifiers, and publishing, in a target queue of the computing system, a bounded list indicating, for each of the transactions, a start boundary for the transaction, the change events associated with the transaction, and an end boundary for the transaction.

Another innovative aspect of the subject matter described in this disclosure can be implemented in a computing system for resolving open transactions. An example system includes one or more processors and at least one memory coupled to the one or more processors and storing instructions that, when executed by the one or more processors, cause the system to perform operations. The operations can include obtaining, at a source component of the computing system, a set of change events, each respective change event including metadata indicating a type of the respective change event and a unique identifier for the respective change event, selectively publishing, at the source component, the change events to a staging queue of the computing system based on the types and the unique identifiers, selectively generating, at a sink component of the computing system that extracts the selectively published change events from the staging queue, boundaries for transactions associated with the change events based on the types and the unique identifiers, and publishing, in a target queue of the computing system, a bounded list indicating, for each of the transactions, a start boundary for the transaction, the change events associated with the transaction, and an end boundary for the transaction.

Another innovative aspect of the subject matter described in this disclosure can be implemented as a non-transitory computer-readable medium storing instructions that, when executed by one or more processors of a system for resolving open transactions, cause the system to perform operations. Example operations include obtaining, at a source component of the computing system, a set of change events, each respective change event including metadata indicating a type of the respective change event and a unique identifier for the respective change event, selectively publishing, at the source component, the change events to a staging queue of the computing system based on the types and the unique identifiers, selectively generating, at a sink component of the computing system that extracts the selectively published change events from the staging queue, boundaries for transactions associated with the change events based on the types and the unique identifiers, and publishing, in a target queue of the computing system, a bounded list indicating, for each of the transactions, a start boundary for the transaction, the change events associated with the transaction, and an end boundary for the transaction.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example computing system, according to some implementations.

FIG. 2 shows an example process flow for resolving open transactions, according to some implementations.

FIG. 3 shows an example process flow for resolving open transactions, according to some implementations.

FIG. 4 shows an example process flow for resolving open transactions, according to some implementations.

FIG. 5A shows an illustrative example for resolving open transactions, according to some implementations.

FIG. 5B shows an illustrative example for resolving open transactions, according to some implementations.

FIG. 5C shows an illustrative example for resolving open transactions, according to some implementations.

FIG. 5D shows an illustrative example for resolving open transactions, according to some implementations.

FIG. 5E shows an illustrative example for resolving open transactions, according to some implementations.

FIG. 5F shows an illustrative example for resolving open transactions, according to some implementations.

FIG. 6 shows an illustrative flowchart depicting an example operation for resolving open transactions, according to some implementations.

Like numbers reference like elements throughout the drawings and specification.

### DETAILED DESCRIPTION

As described above, managing large, distributed datasets in modern databases presents significant computational and operational challenges, especially when stringent Service Level Agreements (SLAs) must be met, and processing large-scale event transactions efficiently and reliably is technically challenging when open transactions are caused by system failures and/or low activity periods. A need exists for a system that can efficiently and reliably resolve open transactions, thereby improving system performance.

In particular, open transactions in a partitioned event streaming system (e.g., such as one using Kafka topics) may arise from the inherent asynchronicity and distributed nature of event ingestion, such as when events related to distinct transactions arrive in a non-contiguous manner within a particular partition. For instance, if a first transaction (“T1”) and a second transaction (“T2”) represent two successive transactions, an open transaction period for T1 may be created when a final event associated with T1 arrives, followed by a period of inactivity before the first event of T2 arrives. This open transaction period may extend from the timestamp of the last T1 event to the timestamp of the first T2 event. It will be appreciated that, in a system configured to close T1 upon the opening of T2, an open transaction for T1 may persist indefinitely if the beginning event for T2 never arrives. Specifically, a source component of the system and/or a sink component of the system may experience a technical failure or temporary disruption of service (such as related to a power outage or controlled restart) and may not receive one or more events during the downtime, thus resulting in one or more open transactions. Such open transaction periods degrade the performance and accuracy of downstream reporting applications and negatively impact end-users by presenting incomplete or outdated transactional data. Such degradation is further increased in low-throughput partitions where infrequent event arrivals may exacerbate the duration of open transactions, leading to extended periods of data unavailability.

Aspects of the present disclosure provide innovative systems and methods for resolving open transactions. A computing system may be used to perform the various operations of the systems and methods disclosed herein. In some implementations, the computing system may be implemented in a data pipeline as a subcomponent of a transaction adapter communicably coupled to other components in the data pipeline. The subcomponents may include, as one example, a source component and a sink component. The source component may obtain change events that each include metadata indicating a type and a unique identifier for the change event. The source component may selectively publish the change events to a staging queue of the data pipeline based on the types and the unique identifiers. By selectively publishing the change events, the source component of the data pipeline facilitates the resolution of open transactions for some potential problem scenarios. Thereafter, the sink component may extract the change events from the staging queue and selectively generate boundaries for transactions associated with the change events based on the types and the unique identifiers. By selectively generating the boundaries, the sink component of the data pipeline further facilitates the resolution of open transactions for other potential problem scenarios. The sink component may also publish a bounded list in a target queue of the data pipeline, where the bounded list indicates a start boundary for each transaction, the change events associated with each transaction, and an end boundary for each transaction. In these and other manners described herein, the source component and the sink component of the data pipeline operate as a resolution engine that can efficiently and effectively resolve open transactions at scale for instances of service disruption, partition failure, or unexpected behavior occurring therein.

In various implementations, the change events are based on changes tracked in a source database. The source database may be one of many databases managed by a relational database management system (RDBMS). Specifically, the RDBMS may create a change log that records the changes, and each change may be linked to a specific transaction. Accordingly, each transaction may correspond to a subset of the changes made to various tables that can span across many source applications. In various implementations, change events that share a same unique identifier are grouped into a same partition in the staging queue. In some instances, the unique identifier is generated based on an identifier associated with an entity related to the change event (such as a username, a customer ID, or the like). In various implementations, the sink component is distributed into multiple instances that each process a subset of the change events. Change events associated with a same unique identifier may be processed by a same sink component instance. Specifically, each instance may be assigned a subset of partitions. In various implementations, the most recent transaction processed for each partition is tracked in a key-value pair data structure. When a new change event is processed, the computing system may compare a unique identifier for the new change event with a unique identifier for a most recent event or transaction, as further described below. Once transactions are resolved and bounded, the target queue may provide the transactions to a data warehouse for further use by downstream reporting applications.

In these and other manners, the computing system described herein provides several technical benefits over conventional solutions for resolving open transactions. By guaranteeing the closure of all open transactions, the system ensures data integrity and eliminates inconsistencies caused by service disruptions, unresolved operations, controlled restarts, partition failures, and the like.

Aspects of the subject matter disclosed herein are not an abstract idea such as a mental process that can be performed in the human mind. For example, the human mind is not capable of resolving open transactions at scale. Further, the human mind is not capable of extracting or receiving change events from a source database over a communications network, such as thousands, millions, billions, or more change events. Nor is the human mind capable of: partitioning massive amounts of change events into a staging queue, generating a bounded list indicating boundaries for transactions associated with the change events, nor performing many of the other actions performable by the computing system described herein. In addition, aspects of the subject matter disclosed herein are not an abstract idea such as a method of organizing human activity because the claims of this patent application do not recite any fundamental economic practice, commercial interaction, legal interaction, or business relations. Moreover, various implementations of the subject matter disclosed herein provide technical solutions to the technical problem of improving the capability and functionality (e.g., speed, accuracy, etc.) of computer-based systems, where the technical solutions can be practically and practicably applied to improve on existing techniques for resolving open transactions. Implementations of the subject matter disclosed herein provide specific inventive steps describing how desired results are achieved and realize meaningful and significant improvements on existing computer functionality—that is, the performance of computer-based systems operating in the evolving technological field of resolving open transactions at scale.

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the aspects of the disclosure. However, it will be apparent to one skilled in the art that these specific details may not be required to practice the example implementations. In other instances, well-known circuits and devices are shown in block diagram form to avoid obscuring the present disclosure. Some portions of the detailed descriptions which follow are presented in terms of procedures, logic blocks, processing, and other symbolic representations of operations on data bits within a computer memory.

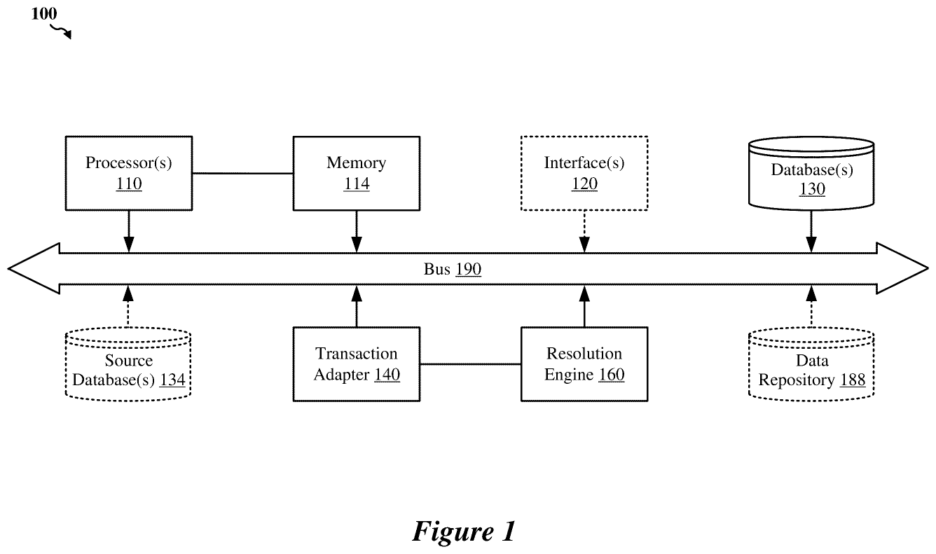

FIG. 1 shows an example computing system 100, according to some implementations. Various aspects of the computing system 100 disclosed herein are generally applicable for resolving open transactions (e.g., at scale). The computing system 100 includes a combination of one or more processors 110, a memory 114 coupled to the one or more processors 110, one or more interfaces 120, one or more databases 130, one or more source databases 134, a transaction adapter 140, a resolution engine 160, and/or a data repository 188. In some implementations, the various components of the computing system 100 are interconnected by at least a data bus 190. In some other implementations, the various components of the computing system 100 are interconnected using other suitable signal routing resources.

The processor 110 includes one or more suitable processors capable of executing scripts or instructions of one or more software programs stored in the computing system 100, such as within the memory 114. In some implementations, the processor 110 includes a general-purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In some implementations, the processor 110 includes a combination of computing devices, such as a combination of a DSP and a microprocessor, a plurality of microprocessors, one or more microprocessors in conjunction with a DSP core, or any other suitable configuration. In some implementations, the processor 110 incorporates one or more hardware accelerators for processing a large amount of data and/or one or more AI accelerators for accelerating AI and machine learning (ML)-based operations, such as one or more graphics processing units (GPUs), one or more tensor processing units (TPUs), one or more neural processing units (NPUs), a wafer-scale integration (WSI) architecture, or the like. For example, the processor 110 may use hardware-based TPUs to process and/or adjust millions, billions, or trillions of artificial neural network (ANN) parameters within seconds, milliseconds, or microseconds.

The memory 114, which may be any suitable persistent memory (such as non-volatile memory or non-transitory memory) may store any number of software programs, executable instructions, machine code, algorithms, and the like that can be executed by the processor 110 to perform one or more corresponding operations or functions. In some implementations, hardwired circuitry is used in place of, or in combination with, software instructions to implement aspects of the disclosure. As such, implementations of the subject matter disclosed herein are not limited to any specific combination of hardware circuitry and/or software.

In some implementations, one or more input/output (I/O) interfaces (e.g., the interface 120) may be used for transmitting or receiving (e.g., over a communications network) transmissions, input data, and/or instructions to or from a computing device (e.g., associated with a user), outputting data (e.g., over the communications network) to the computing device, or the like. The interface 120 may also be used to provide or receive other suitable information, such as computer code for updating one or more programs stored on the computing system 100, internet protocol requests and results, or the like. An example interface includes a wired interface or wireless interface to the Internet or other means to communicably couple with user devices or any other suitable devices. In an example, the interface 120 includes an interface with an ethernet cable to a modem, which is used to communicate with an internet service provider (ISP) directing traffic to and from user devices and/or other parties. In some implementations, the interface 120 is also used to communicate with another device within the network to which the computing system 100 is coupled, such as a smartphone, a tablet, a personal computer, or other suitable electronic device. In various implementations, the interface 120 includes a display, a speaker, a mouse, a keyboard, or other suitable input or output elements that allow interfacing with the computing system 100 by a local user or moderator.

The database 130 may store data associated with the computing system 100, such as changes, events, change data capture (CDC) information, event bus (EB) information, transaction information and/or metadata, transaction boundaries, bounded lists, identifiers, partition information, queue information, change logs, source application information, table information, entity information, user information, customer information, partition distribution information, processing caches, error information, among other suitable information. In some implementations, the database 130 incorporates one or more aspects of a database management system (DBMS) or a relational DBMS (RDBMS). In various implementations, the database 130 may store data associated with transmissions, requests, responses, applications, instructions, user data, action information, configurations, thresholds, filters, data assets, preferences, priorities, timestamps, models, algorithms, modules, engines, user information, historical data, recent data, current or real-time data, files, plugins, metadata, arrays, tags, queries, feedback, insights, formats, features, among other suitable information. In various implementations, the database 130 may store data in one or more cloud object storage services, such as one or more Amazon Web Services (AWS)-based Simple Storage Service (S3) buckets. In various implementations, the data may be stored in one or more JavaScript Object Notation (JSON) files, comma-separated values (CSV) files, or any other suitable data objects for processing by the computing system 100. In some implementations, the data may be stored in one or more Structured Query Language (SQL) compliant data sets for filtering, querying, and sorting, or any other suitable format for processing by the computing system 100. In various implementations, the database 130 includes a relational database capable of presenting information as data sets in tabular form and capable of manipulating the data sets using relational operators. In various implementations, the database 130 is a part of or separate from the source database 134, the data repository 188, and/or another suitable physical or cloud-based data store.

In some implementations, a source database (e.g., the source database 134) stores data associated with change events, such as the change events themselves, metadata, CDC information, EB information, transaction information, identifiers, logs, tables, hash values, among other information related to change events. In some implementations, the source database 134 is one of a plurality of source databases managed by the database 130. The source database 134 may incorporate aspects of MySQL, Postgres, Cassandra, DynamoDB, or another suitable database for serving end-users for operations involving change events such as inserts, reads, updates, and deletes.

The change events stored in the source database 134 may be extracted from a change log (e.g., generated by the database 130) based on changes made to tables used by various source applications. Specifically, the change events may represent modifications within the source database 134 that are extracted from the change log. The change log may include inserts, reads, updates, and deletes based on one or more aspects of CDC, such as timestamp-based tracking, log-based capture, trigger-based mechanisms, or the like. Each change event may be associated with one of a plurality of unique identifiers. Furthermore, each change event may be one of a subset of change events related to a particular transaction. For instance, subsets of the change events may each be associated with various changes made (e.g., by an entity that executed the event or other entities associated with the executing entity) to various tables distributed across various applications.

As a non-limiting example, a subset of the change events related to a single return-based transaction in an e-commerce system may include: an inventory table managed by an inventory application being updated to increase the available stock for the returned item, a customer feedback table being updated to reflect a return and capture any related customer feedback, a return shipment being logged by a shipping application in a return logistics table including return status and carrier details, a return inspection table being modified by a warehouse management application to document any outcome of the product inspection and whether the item can be resold, a loyalty points table being updated by a customer account application to deduct any points earned from the returned purchase, and an email notification application logging the transmission of a return confirmation email to the customer in a notification table.

The transaction adapter 140 may include various subcomponents, such as one or more subcomponents of a source component, a staging queue, one or more subcomponents of a sink component, and a target queue. The resolution engine 160 may also include various subcomponents, such as one or more other subcomponents of the source component and one or more other subcomponents of the sink component. Specifically, the subcomponents of the source component and the sink component included in the resolution engine 160 may be configured to perform the innovative techniques described herein related to resolving open transactions. In some implementations, the transaction adapter 140 and the innovative aspects of the resolution engine 160 described herein are incorporated into a single component for processing transactions. In some other implementations, the innovative aspects of the resolution engine 160 described herein are incorporated into a standalone component for resolving open transactions that can function as a sub-adapter for a transaction adapter (e.g., the transaction adapter 140). Various operations performed by the (sub)components are described below.

For example, a source component may be used to obtain change events from the source database 134, such as by obtaining the change events from a transmission received over a communications network. In some implementations, the source component is a database adapter that reads change events or associated updates from bin logs or write-ahead files in the source database 134. As one example, the source component may be a Debezium engine that reads CDC events from a PostgreSQL bin log stored in the source database 134. For purposes of discussion herein, one or more subcomponents of the source component may also be referred to as an event emitter, an event producer, or another suitable term for a component that generates events or messages based on actions, changes, or processes extracted from the source database 134 and that sends or publishes the events or messages to an intermediary queue, topic, channel, or system (e.g., a staging queue) for further processing. In some instances, the subcomponents of the source component included in the transaction adapter 140 may be used to partition the change events into the staging queue.

As another example, a staging queue may include a plurality of partitions into which the change events are split or partitioned. The staging queue may operate as an intermediary layer that temporarily holds the change events from the source component until they are consumed downstream, such as by the sink component. In some implementations, the staging queue is a Kafka staging topic divided into partitions for parallel processing. In some aspects, the staging queue may be used to maintain state information of events being processed for a given partition. In various implementations, alternatives to Kafka may include RabbitMQ, AWS Simple Queue Service (SQS), Azure Event Grid, or any other messaging system. For purposes of discussion herein, the staging queue may also be referred to as a message queue, a message broker, event stream, or another suitable term for a component that stores and delivers messages or a continuous flow of events.

As another example, a sink component may be used to consume change events from an intermediary layer (e.g., the staging queue), process and/or transform the change events, and prepare the change events for delivery to a target queue. In some implementations, the sink component is a distributed sink component including multiple sink component instances across a distributed system to facilitate parallel processing of data from the staging queue. In some implementations, each sink component instance may be referred to as a pod, such as in a Kubernetes-based implementation. In various other implementations, each sink component instance may be referred to as a worker, a process, an instance, a container, a node, an actor, a thread, or another suitable term referring to an individual of a whole cooperatively consuming and processing data from the staging queue. For purposes of discussion herein, the sink component may also be referred to as a sink, a sink component, an event consumer, an event processor, a consumer group, or another suitable term to describe a group of components that work together to ingest data from various partitions of a staging queue into a target queue. The sink component may be used to generate a bounded list based on the change events. The bounded list generated by the sink component may indicate a sequential list of transactions and, for each respective transaction processed for each partition, a start boundary for the respective transaction, the change events associated with the respective transaction, and an end boundary for the respective transaction.

As another example, a target queue may be used to store the change events and their corresponding transaction boundaries. In some aspects, the staging queue operates as an intermediary layer that temporarily holds the change events from the sink component until they are consumed downstream, such as by the data repository 188. In some implementations, the target queue includes a plurality of partitions (e.g., the same number of partitions as the staging queue) into which the events and boundaries are split or partitioned. For instance, similar to the staging queue, change events associated with a same unique identifier may be stored in a same partition. In some implementations, the target queue is a Kafka target (or “final”) topic divided into partitions for parallel processing. In various implementations, alternatives to Kafka may include RabbitMQ, AWS Simple Queue Service (SQS), Azure Event Grid, or any other messaging system. For purposes of discussion herein, the target queue may also be referred to as a message queue, a message broker, event stream, or another suitable term for a component that stores and delivers messages or a continuous flow of events.

The data repository 188 may store data associated with transactions, such as the transactions themselves (including their corresponding events and any transaction boundaries). In various implementations, the data repository 188 may be any repository structure suitable for efficient querying and analysis of transactional data, such as for real-time monitoring and/or historical trend analysis. In some instances, the data repository 188 is a data warehouse or another suitable data store that serves as a central repository for historical transactional data and that may be integrated with one or more other data sources. For instance, the data warehouse may include one or more data marts coupled to one or more reporting applications. The one or more reporting applications may use the data mart for generating reports, dashboards, visualizations, and the like, thereby enabling users to gain insights into various metrics (e.g., key performance indicators (KPIs)) associated with the change events and to make informed decisions based on the metrics.

The source database 134, the transaction adapter 140, the resolution engine 160, and/or the data repository 188 are implemented in software, hardware, or a combination thereof. In some implementations, any one or more of the source database 134, the transaction adapter 140, the resolution engine 160, or the data repository 188 is embodied in instructions that, when executed by the processor 110, cause the computing system 100 to perform operations. In various implementations, the instructions of one or more of said components and/or the interface 120 are stored in the memory 114, the database 130, or a different suitable memory, and are in any suitable programming language format for execution by the computing system 100, such as by the processor 110. It is to be understood that the particular architecture of the computing system 100 shown in FIG. 1 is but one example of a variety of different architectures within which aspects of the present disclosure can be implemented. For example, in some implementations, components of the computing system 100 are distributed across multiple devices, included in fewer components, and so on. While the below examples related to resolving open transactions are described with reference to the computing system 100, other suitable system configurations may be used.

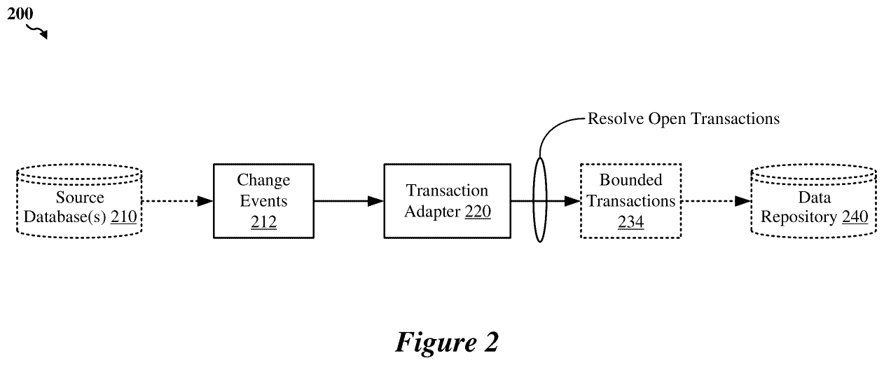

FIG. 2 shows an example process flow 200 for resolving open transactions, according to some implementations, and may be performed by a computing system, such as the computing system 100 described with respect to FIG. 1. The example process flow 200 shows a source database 210, a transaction adapter 220, and a data repository 240, which may be examples of the source database 134, the transaction adapter 140, and the data repository 188 described with respect to FIG. 1, respectively. In some implementations, the transaction adapter 220 includes various subcomponents, such as one or more subcomponents of a source component, a staging queue, one or more subcomponents of a sink component, and a target queue, which may be examples of the source component, the staging queue, the sink component, and the target queue described with respect to FIG. 1, respectively. In some implementations, a resolution engine (e.g., the resolution engine 160 described with respect to FIG. 1) is configured to resolve open transactions within the transaction adapter 220 and may include one or more subcomponents of the source component and one or more subcomponents of the sink component.

The example process flow 200 starts with obtaining change events 212 at transaction adapter 220. In some instances, the transaction adapter 220 obtains the change events 212 from a transmission received over a communications network from the source database 210. The change events may be extracted from a change log generated by the source database 210. Each change event may include metadata indicating a type of the change event and a unique identifier for the change event.

The example process flow 200 continues with the transaction adapter 220 (e.g., in conjunction with the resolution engine 160) generating bounded (and resolved) transactions 234 based on the change events 212. The innovative techniques described herein may be used to resolve any open transactions therein. For example, the source component of the resolution engine 160 may selectively publish the change events to the staging queue based on the types and the unique identifiers. As another example, the sink component of the resolution engine 160 may selectively generate boundaries for transactions associated with the change events based on the types and the unique identifiers. The bounded transactions 234 may be published (e.g., in the target queue) as a bounded list indicating, for each of the transactions, a start boundary for the transaction, the change events associated with the transaction, and an end boundary for the transaction.

In some implementations, the bounded transactions 234 are stored in the data repository 240, which may be a data warehouse including a data mart coupled to one or more reporting applications. By ensuring that all transactions are finalized accurately and in a timely manner, the reporting applications are enabled to generate reliable and up-to-date insights, thus further enabling informed decision-making and operational efficiency by downstream users.

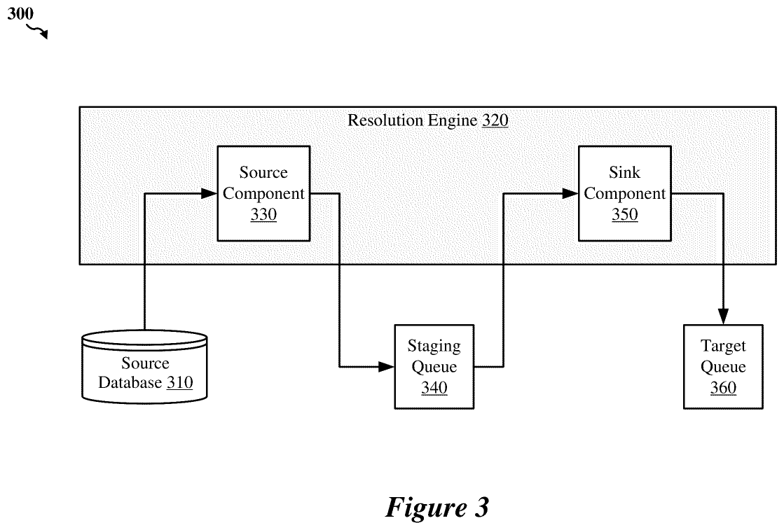

FIG. 3 shows an example process flow 300 for resolving open transactions, according to some implementations, and may be performed by a computing system, such as the computing system 100 described with respect to FIG. 1. The example process flow 300 shows a source database 310, which may be an example of the source database 210 described with respect to FIG. 2. The example process flow 300 also shows a resolution engine 320, a source component 330, a staging queue 340, a sink component 350, and a target queue 360, which may be examples of the resolution engine, source component, staging queue, sink component, and target queue discussed above.

In some implementations, change events are obtained from the source database 310 at the source component 330, where the change events include metadata. In accordance with the innovative techniques described herein, the source component 330 subcomponent of the resolution engine 320 may selectively publish the change events to the staging queue 340 based on the metadata. In some implementations, the selectively published change events are extracted from the staging queue 340 at the sink component 350, where the selectively published change events still include the metadata. In accordance with the innovative techniques described herein, the sink component 350 subcomponent of the resolution engine 320 may selectively generate boundaries for transactions associated with the change events based on the metadata. In some implementations, the selectively published change events are published in the target queue 360 in order with their corresponding selectively generated boundaries.

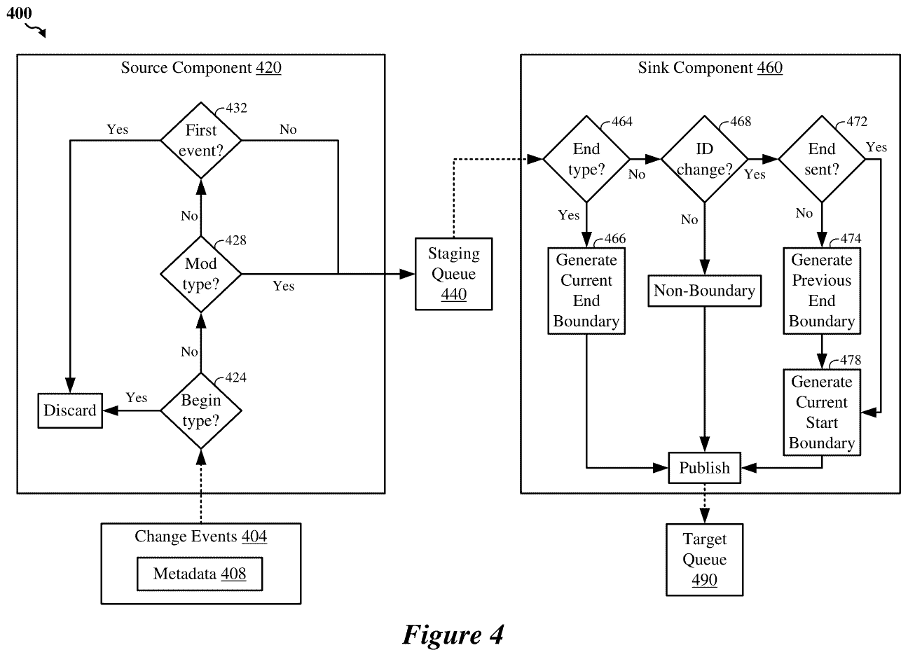

FIG. 4 shows an example process flow 400 for resolving open transactions, according to some implementations, and may be performed by a computing system, such as the computing system 100 described with respect to FIG. 1. The example process flow 400 shows a source component 420, a staging queue 440, a sink component 460, and a target queue 490, which may be examples of the source component 330, the staging queue 340, the sink component 350, and the target queue 360 described with respect to FIG. 3, respectively.

The example process flow 400 starts with obtaining, at the source component 420, change events 404 including metadata 408. In some implementations, the metadata indicates a type of each change event and a unique identifier for each change event. In some instances, ones of the events may be flagged as a “transaction begin” type or a “transaction end” type, such as based on enabling a “provide.transaction.metadata” parameter in a Debezium library or the like. It will be appreciated that, although the event flags may appropriately flag transaction begin and transaction end events for some transactions, service disruptions (e.g., at the source component 420 and/or the sink component 460) may result in one or more flags (and/or non-flag events) being missed and/or received in duplicate. In various implementations, obtaining the change events 404 includes extracting the change events 404 from a source database, such as the source database 310. In some instances, the source database 310 is one of a plurality of source databases managed by a database management system (DBMS) serving a plurality of source applications, and the change events 404 are extracted from a change log generated by the DBMS based on changes made to tables used by the plurality of source applications. In some aspects, each of the transactions corresponds to a subset of the changes made to the tables distributed across the plurality of source applications.

The example process flow 400 continues at decision block 424, where the source component 420 selectively discards the change events 404 based on determining whether the type of the change event is a transaction begin type (e.g., that the event was flagged as a transaction begin event). Specifically, the source component 420 discards the change event if the type of the change event is a transaction begin type. By contrast, the source component 420 advances the change event for further processing if the type of the change event is not a transaction begin type.

The example process flow 400 continues at decision block 428, where the source component 420 selectively publishes the remaining change events to the staging queue 440 based on determining whether the type of the remaining change event is a modification type. Modification type change events may be change data capture (CDC) events and include “add” type change events, “delete” type change events, and “update” type change events, for example. Other examples may include a “rename” type, a “move” type, a “merge” type, a “split” type, a “replace” type, an “archive” type, a “restore” type, or the like. Specifically, the source component 420 publishes the change event to the staging queue 440 if the type of the change event is a modification type. By contrast, the source component 420 advances the change event for further processing if the type of the change event is not a modification type.

The example process flow 400 continues at decision block 432, where the source component 420 selectively publishes or discards each remaining change event based on whether the remaining change event is a first event for a transaction. The source component 420 may determine whether the remaining change event is a first event for a transaction based on its unique identifier. Specifically, the source component 420 may publish the change event to the staging queue 440 responsive to determining that its unique identifier has been published to the staging queue 440 in connection with at least one other change event. For example, if at least one of the change events selectively published to the staging queue 440 at decision block 428 is associated with the same unique identifier as the current change event being processed at decision block 432, the current change event may be published to the staging queue 440 because it is not the first event for a transaction. By contrast, the source component 420 may discard the current change event responsive to determining that its unique identifier has not been published to the staging queue 440 in connection with at least one other change event because this indicates that the current change event is the first event for a transaction.

In some implementations, after determining that the current change event is not a first event for a transaction at decision block 432, the source component 420 determines that a type of the current change event is a transaction end type, identifies a transaction associated with at least one other change event (e.g., published in association with the same unique identifier at decision block 428), and publishes the current change event as a final event for the identified transaction. In some instances, the current change event is published as the final event for the identified transaction responsive to determining that a first event for a next transaction is about to be published to the staging queue 440. For example, after determining that the current change event is not a first event for a transaction at decision block 432, the source component 420 may wait until a first event for a new transaction (e.g., associated with a new unique identifier) is about to be published to the staging queue 440 (e.g., at decision block 428), and then publish the final event for the previous transaction just before the first event for the new transaction.

In these and other manners, the source component 420 selectively publishes the change events 404 to the staging queue 440 based on the metadata. The sink component 460 may extract the selectively published change events 404 from the staging queue 440.

The example process flow 400 continues at decision block 464, where the sink component 460 selectively generates, for each extracted change event, an end boundary for its associated transaction (the “current transaction”) based on determining whether the type of the extracted change event is a transaction end type. Specifically, at decision block 466, the sink component 460 generates an end boundary for the current transaction if the type of the extracted change event is a transaction end type. The end boundary may be published to the target queue 490 in connection with the current transaction. By contrast, the sink component 460 advances the extracted change event for further processing if the type of the extracted change event is not a transaction end type. In some implementations, responsive to generating an end boundary for a current transaction, the sink component 460 will refrain from generating any duplicate end boundaries for the current transaction, such as if additional end type events are received in association with the same unique identifier.

The example process flow 400 continues at decision block 468, where, for each remaining change event, the sink component 460 determines whether the remaining change event is a non-boundary event based on a comparing its unique identifier with a most recently processed change event (e.g., such as retrieved from memory). Thereafter, the sink component 460 selectively publishes the remaining change event to the target queue 490 based on results of the comparison. Specifically, the sink component 460 publishes the remaining change event to the target queue 490 responsive to determining that the unique identifier for the remaining change event is the same as the unique identifier for the most recently processed change event. The remaining change event may be published to the target queue 490 in connection with a same transaction as the most recently processed change event. By contrast, the sink component 460 advances the remaining change event for further processing responsive to determining that the unique identifier for the remaining change event is different than the unique identifier for the most recently processed change event. In some implementations, responsive to publishing an end boundary for a current transaction (e.g., at decision block 464), the sink component 460 will refrain from publishing any duplicate non-boundary events for the current transaction.

The example process flow 400 continues at decision block 472, where, for each remaining change event, the sink component 460 determines whether an end boundary was published for the transaction associated with the most recently processed transaction (i.e., the transaction that came just before the transaction associated with the remaining change event currently being processed). Based on the determination, the sink component 460 selectively generates an end boundary for the most recently processed transaction based on whether a presence of the existing end boundary for the most recently processed transaction is detected. Specifically, at block 474, the sink component 460 generates the end boundary for the most recently processed transaction responsive to not detecting a presence of an existing end boundary for the most recently processed transaction. In such instances, at block 478, the sink component 460 may also generate a start boundary for the current transaction (i.e., the transaction associated with the remaining change event currently being processed). The end boundary and the start boundary may be published to the target queue 490 in connection with the most recently processed transaction and the current transaction, respectively. By contrast, if at decision block 472, the sink component 460 detects the presence of the existing end boundary for the most recently processed transaction, the sink component 460 refrains from generating the end boundary for the most recently processed transaction. In such instances, at block 478, the sink component 460 generates a start boundary for the current transaction (i.e., associated with the change event currently being processed), and publishes the start boundary to the target queue 490 in connection with the current transaction.

In these and other manners, the sink component 460 selectively generates boundaries for transactions associated with the change events based on the metadata.

The example process flow 400 continues with publishing, in the target queue 490, a bounded list indicating, for each of the transactions, a start boundary for the transaction, the change events associated with the transaction, and an end boundary for the transaction. In some implementations, the bounded transactions are provided to a data repository (e.g., the data repository 240) based on the bounded list. In some instances, the data repository 240 is a data mart coupled to one or more reporting applications.

In various implementations, the source component 420 selectively publishes the change events 404 into a plurality of partitions of the staging queue 440 based on the unique identifiers, where change events associated with a same transaction are partitioned into a same partition. In various of such implementations, the sink component 460 is a distributed sink component including a plurality of sink component instances that parallelly process the change events from the partitions of the staging queue 440 based on a partition map. In such implementations, the bounded list may include partition indicators indicating, for each respective transaction, the one of the partitions to which the respective transaction is assigned, and the distributed sink component 460 may publish the bounded list into partitions of the target queue 490 corresponding to the partitions of the staging queue 440 based on the partition indicators.

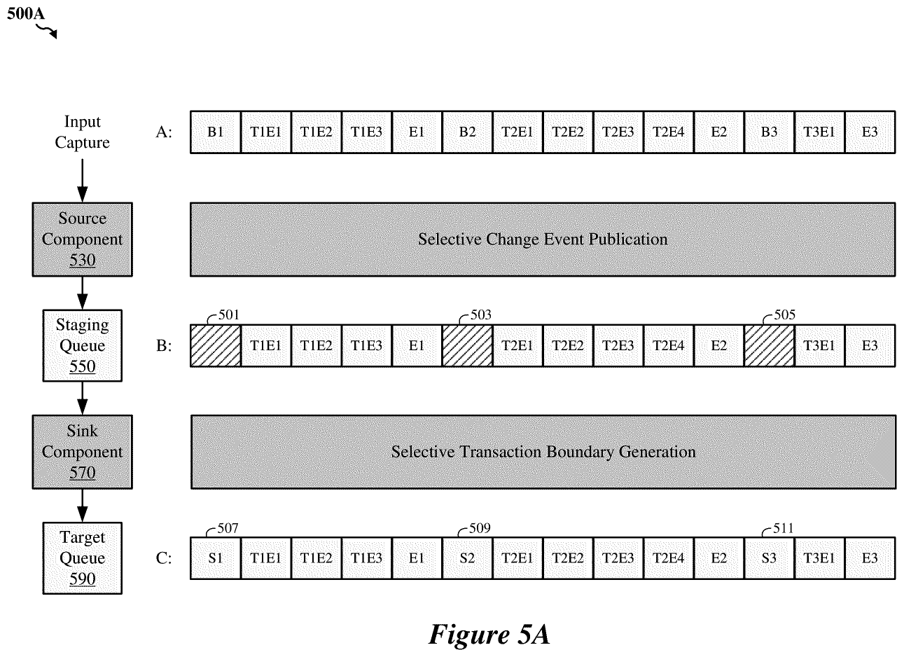

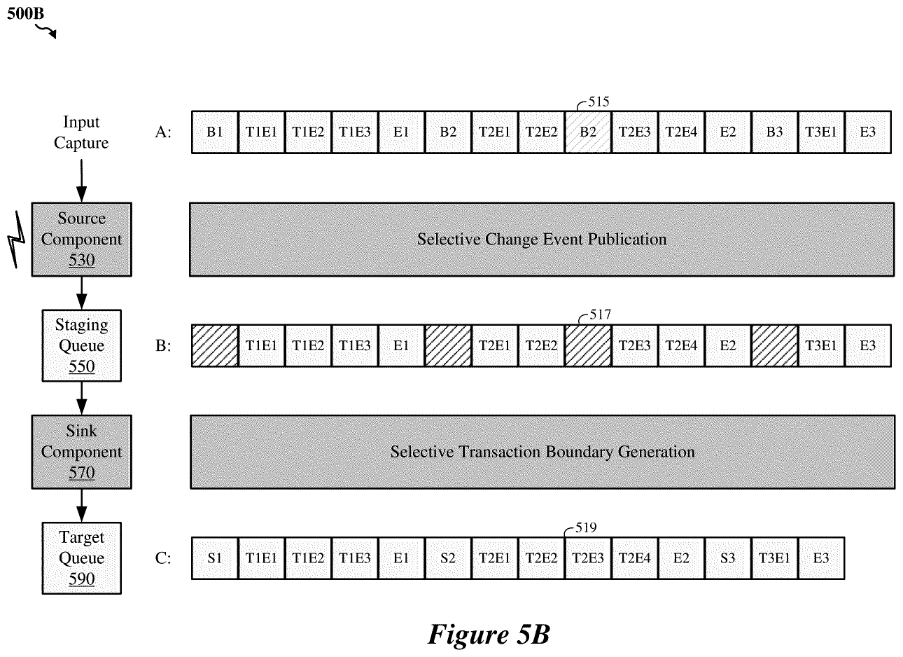

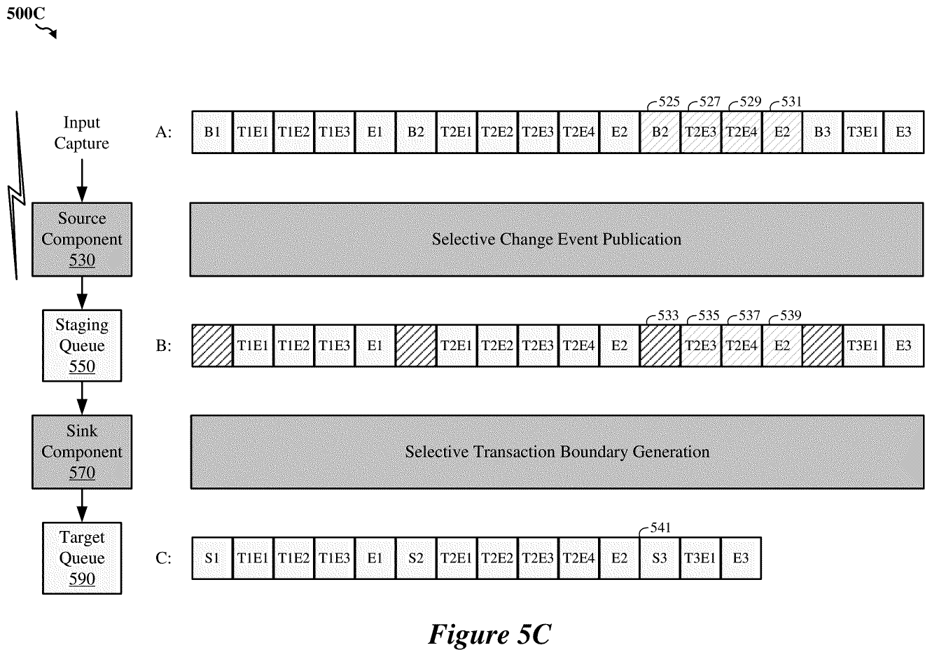

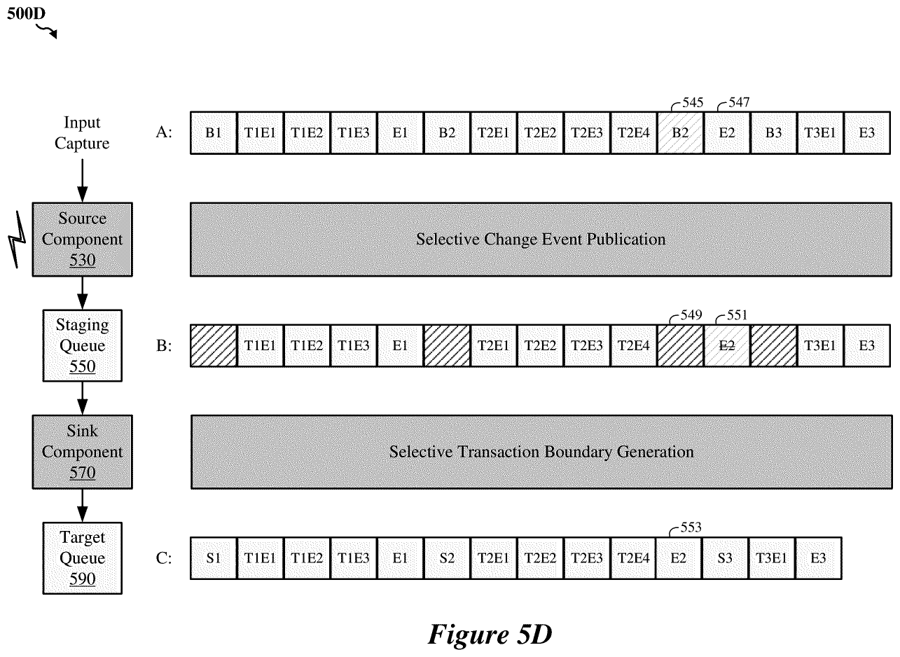

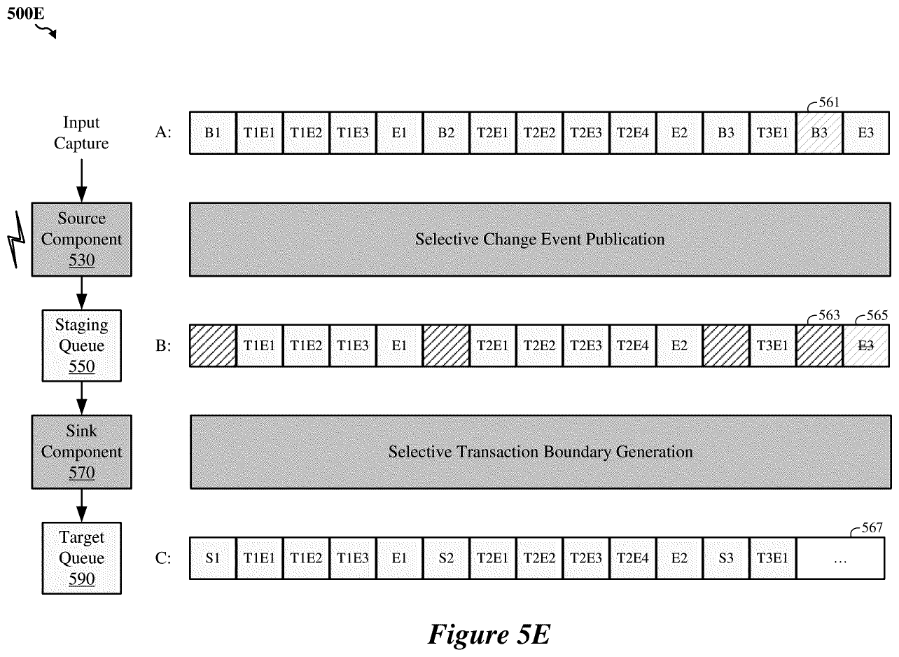

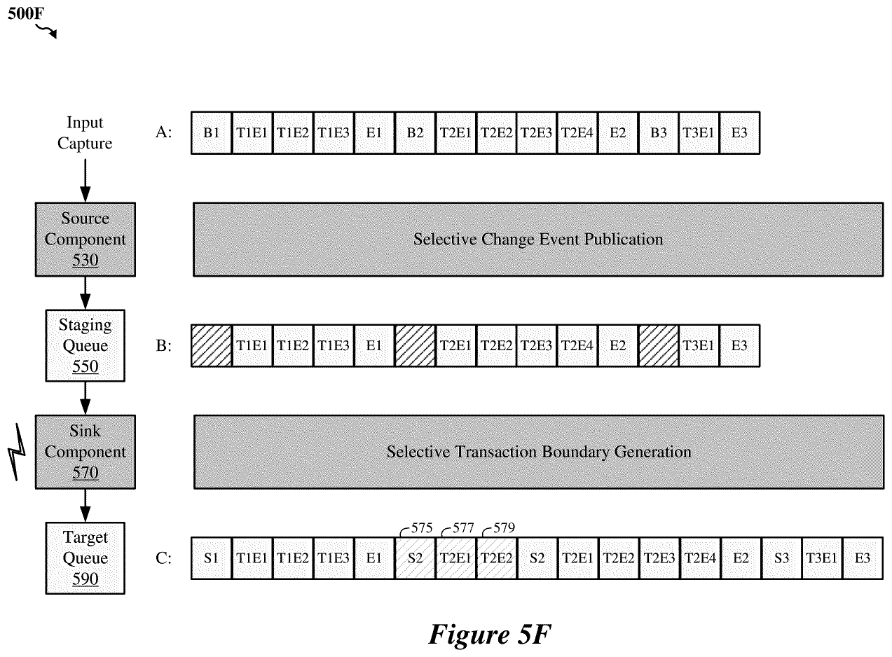

FIG. 5A shows an illustrative example 500A for resolving open transactions, according to some implementations. The associated operations may be performed by a computing system, such as the computing system 100 described with respect to FIG. 1. The illustrative example 500A shows a source component 530, a staging queue 550, a sink component 570, and a target queue 590, which may be examples of the source component 420, the staging queue 440, the sink component 460, and the target queue 490, described with respect to FIG. 4, respectively.

An input capture including a set of change events (shown as Row “A”) is shown, which may be referred to as the “input events A.” In some implementations, the input events A may correspond to an output of an adapter, such as a Debezium adapter communicably coupled to a source database, such as the source database 310 of FIG. 3. In some instances, one or more of the input events A may be different than the change events stored in the source database 310, such as when there is a service disruption. It will be appreciated that input events A is a simplified set of change events for illustrative purposes and that an actual set of change events obtained by the source component 530 may include thousands, millions, or even billions of change events. For ease of discussion, each change event illustrated includes a label. A change event labeled with an “E” prefix indicates a “Transaction End” event, where “E2” indicates a “Transaction End” event for “T2” (i.e., “Transaction 2”), for example. A “TXEY” label indicates the Y^{th} change event for the X^{th} Transaction. For instance, a change event labeled “T2E3” indicates the 3^{rd} change event for the 2^{nd} Transaction. A change event labeled with a “B” prefix indicates a “Transaction Begin” event, where “B1” indicates a “Transaction Begin” event for “T1” (i.e., “Transaction 1”), for example. A change event labeled with an “S” prefix similarly indicates a “Transaction Start” event, where “S1” indicates a “Transaction Start” event for “T1” (i.e., “Transaction 1”), for example. It will be appreciated that “Transaction Begin” and “Transaction Start” both signify the commencement of a new transaction; however, for purposes of discussion herein, a “Transaction Begin” event (e.g., B1) is a flag (such as generated by the Debezium adapter) included in the input captured by the source component 530, whereas a “Transaction Start” event (e.g., S1) is a start boundary marker generated by the sink component 570. By contrast, a “Transaction End” event (e.g., E1) in the A column or B column represents a flag (such as generated by the Debezium adapter) included in the input captured by the source component 530; whereas a “Transaction End” event (e.g., E1) in the C column represents an end boundary marker generated by the sink component 570. As further described below in connection with the various illustrative examples, boxes with no label (or only a diagonal line pattern) and/or a struckthrough label may be shown for discussion purposes only and may not actually be published or generated.

The illustrative example 500A begins with the source component 530 obtaining the input events A. For this example, the input events A include a beginning flag (B1) for Transaction 1(T1), three events for T1, an end flag for T1 (E1), a beginning flag for T2 (B2), four events for T2, an end flag for T2 (E2), a beginning flag for T3 (B3), one event for T3, and an end flag for T3 (E3).

In accordance with the innovative techniques described herein, the source component 530 selectively publishes the input events A to the staging queue 550, such as in one or more of the manners described with respect to FIG. 4. The set of selectively published change events (shown as Row “B”) may be referred to as the “staged events B.” For instance, the source component 530 discards ones of the input events A that are of a transaction begin type, such as described with respect to decision block 424 of FIG. 4. For this example, the source component 530 discards B1, B2, and B3, which are represented by empty boxes 501, 503, and 505, respectively. The source component 530 also publishes ones of the input events A that are of a modification type (i.e., T1E1, T1E2, T1E3, T2E1, T2E2, T2E3, T2E4, and T3E1), such as described with respect to decision block 428 of FIG. 4. The source component 530 also selectively publishes or discards each remaining change event based on its unique identifier, such as described with respect to decision block 432 of FIG. 4. Specifically, for this example, the source component 530 publishes E1 responsive to determining that its unique identifier has been published in connection with at least one other change event (e.g., T1E3), publishes E2responsive to determining that its unique identifier has been published in connection with at least one other change event (e.g., T2E4), and publishes E3 responsive to determining that its unique identifier has been published in connection with at least one other change event (e.g., T3E1).

In accordance with the innovative techniques described herein, the sink component 570 selectively generates boundaries for the staged events B, such as in one or more of the manners described with respect to FIG. 4. The set of selectively published change events along with their selectively generated boundaries is shown in Row “C” and may be referred to as the “bounded events C.” For instance, the sink component 570 generates an end boundary for ones of the staged events B that are of a transaction end type (i.e., E1, E2, and E3), as described with respect to decision block 466 of FIG. 4. The sink component 570 also publishes ones of the non-boundary events (i.e., T1E2, T1E3, T2E2, T2E3, and T2E4) of the staged events B based on determining that their unique identifier is not the same as the most recently processed change event, as described with respect to decision block 468 of FIG. 4. For each remaining staged event B (i.e., T1E1, T2E1, and T3E1), the sink component 570 first determines whether an end event for the previous transaction has already been published and selectively generates boundaries based on the determination, as described with respect to decision block 472 of FIG. 4. Specifically, for T1E1, the sink component 570 determines that there is no previous transaction (i.e., T1 is the first transaction) and thus refrains from generating an end boundary for any previous transaction. As described with respect to block 478 of FIG. 4, the sink component 570 also generates and publishes a start boundary (S1) for the transaction associated with T1E1 (T1) prior to publishing T1E1, as shown at box 507. For T2E1, the sink component 570 determines that an end event (E1) has already been published at the target queue 590 for the previous transaction (T1) and thus refrains from generating an end boundary for T1 and proceeds to generate and publish a start boundary (S2) for T2 prior to publishing T2E1, as shown at box 509. Similarly, for T3E1, the sink component 570 determines that an end event (E2) has already been published at the target queue 590 for the previous transaction (T2) and thus refrains from generating an end boundary for T2 and proceeds to generate and publish a start boundary (S3) for T3 prior to publishing T3E1, as shown at box 511.

Thereafter, the bounded events C may be output as a bounded list of finalized transactions, such as to a data repository (e.g., the data repository 240 of FIG. 2).

FIG. 5B shows an illustrative example 500B for resolving open transactions, according to some implementations. The associated operations may be performed by a computing system, such as the computing system 100 described with respect to FIG. 1. The illustrative example 500B shows the same source component 530, staging queue 550, sink component 570, and target queue 590 described above.

The illustrative example 500B begins with the source component 530 obtaining input events A. For this example, the input events A include a beginning flag (B1) for T1, three events for T1, an end flag for T1 (E1), a beginning flag for T2 (B2), four events for T2, an end flag for T2 (E2), a beginning flag for T3 (B3), one event for T3, and an end flag for T3 (E3). As shown at box 515, the input events A also include a duplicate beginning flag for T2 (B2). For example, as illustrated by a lightning bolt, the duplicate flag may be caused by the source component 530 experiencing a service disruption (e.g., a restart) during T2.

In accordance with the innovative techniques described herein, the source component 530 selectively publishes the input events A to the staging queue 550 (i.e., “staged events B”). Specifically, the source component 530 discards ones of the input events A that are of a transaction begin type (i.e., B1, B2, duplicate B2, and B3), where empty box 517 represents the discarded duplicate B2. The source component 530 also publishes ones of the input events A that are of a modification type (i.e., T1E1, T1E2, T1E3, T2E1, T2E2, T2E3, T2E4, and T3E1). The source component 530 also selectively publishes or discards each remaining change event based on its unique identifier. Specifically, for this example, E1 is published due to its unique identifier matching T1E3, E2 is published due to its unique identifier matching T2E4, and E3 is published due to its unique identifier matching T3E1.

In accordance with the innovative techniques described herein, the sink component 570 selectively generates boundaries for the staged events B, where the set of selectively published change events along with their selectively generated boundaries is shown in Row “C” and may be referred to as “bounded events C.” Specifically, the sink component 570 generates an end boundary for ones of the staged events B that are of a transaction end type (i.e., E1, E2, and E3). The sink component 570 also publishes ones of the non-boundary events (i.e., T1E2, T1E3, T2E2, T2E3, and T2E4) of the staged events B based on determining that their unique identifier is not the same as the most recently processed change event. For each remaining staged event B (i.e., T1E1, T2E1, and T3E1), the sink component 570 first determines whether an end event for the previous transaction has already been published and selectively generates boundaries based on the determination. For this example, S1, S2, and S3 are generated and published prior to publishing T1E1, T2E1, and T3E1, respectively, for the same reasons as described with respect to FIG. 5A. As shown at position 519, the bounded events C do not include the duplicate B2 (nor a duplicate S2) and thus any adverse effects that may have otherwise been caused downstream by an apparent open transaction are prevented.

Thereafter, the bounded events C may be output as a bounded list of finalized transactions, such as to a data repository (e.g., the data repository 240 of FIG. 2).

FIG. 5C shows an illustrative example 500C for resolving open transactions, according to some implementations. The associated operations may be performed by a computing system, such as the computing system 100 described with respect to FIG. 1. The illustrative example 500B shows the same source component 530, staging queue 550, sink component 570, and target queue 590 described above.

The illustrative example 500C begins with the source component 530 obtaining input events A. For this example, the input events A include a beginning flag (B1) for T1, three events for T1, an end flag for T1 (E1), a beginning flag for T2 (B2), four events for T2, an end flag for T2 (E2), a beginning flag for T3 (B3), one event for T3, and an end flag for T3 (E3). As shown at boxes 525, 527, 529, and 531, the input events A also include a duplicate beginning flag for T2 (B2), two duplicate events for T2 (T2E3 and T2E4), and a duplicate end flag for T2 (E2), respectively. For example, as illustrated by a lightning bolt, the duplicate events may be caused by a service disruption during T2, such as the source component 530 undergoing a restart and/or a data replay operation occurring before all events are committed to the input capture adapter.

In accordance with the innovative techniques described herein, the source component 530 selectively publishes the input events A to the staging queue 550 (i.e., “staged events B”). Specifically, the source component 530 discards ones of the input events A that are of a transaction begin type (i.e., B1, B2, duplicate B2, and B3), where empty box 533 represents the discarded duplicate B2. The source component 530 also publishes ones of the input events A that are of a modification type (i.e., T1E1, T1E2, T1E3, T2E1, T2E2, T2E3, T2E4, duplicate T2E3 (box 535), duplicate T2E4 (box 537), and T3E1). The source component 530 also selectively publishes or discards each remaining change event based on its unique identifier. Specifically, for this example, E1 is published due to its unique identifier matching T1E3, E2 is published due to its unique identifier matching T2E4, duplicate E2 (box 539) is published due to its unique identifier matching duplicate T2E4, and E3 is published due to its unique identifier matching T3E1.

In accordance with the innovative techniques described herein, the sink component 570 selectively generates boundaries for the staged events B, where the set of selectively published change events along with their selectively generated boundaries is shown in Row “C” and may be referred to as “bounded events C.” Specifically, the sink component 570 generates an end boundary for ones of the staged events B that are of a transaction end type (i.e., E1, E2, and E3). To note, responsive to generating a first end boundary for T2 based on the first E2, the sink component 570 will refrain from generating a duplicate end boundary for T2 based on duplicate E2. The sink component 570 also publishes ones of the non-boundary events (i.e., T1E2, T1E3, T2E2, T2E3, and T2E4) of the staged events B based on determining that their unique identifier is not the same as the most recently processed change event. To note, responsive to publishing an end boundary for T2 based on the first E2, the sink component 570 will refrain from publishing the duplicate non-boundary events for T2 (i.e., T2E3 and T2E4). For each remaining staged event B (i.e., T1E1, T2E1, and T3E1), the sink component 570 first determines whether an end event for the previous transaction has already been published and selectively generates boundaries based on the determination. For this example, S1, S2, and S3are generated and published prior to publishing T1E1, T2E1, and T3E1, respectively, for the same reasons as described with respect to FIG. 5A. As shown at position 541, the bounded events C also do not include the duplicate events described above and thus any adverse effects that may have otherwise been caused downstream by an apparent open transaction are prevented.

Thereafter, the bounded events C may be output as a bounded list of finalized transactions, such as to a data repository (e.g., the data repository 240 of FIG. 2).

FIG. 5D shows an illustrative example 500D for resolving open transactions, according to some implementations. The associated operations may be performed by a computing system, such as the computing system 100 described with respect to FIG. 1. The illustrative example 500B shows the same source component 530, staging queue 550, sink component 570, and target queue 590 described above.

The illustrative example 500D begins with the source component 530 obtaining input events A. For this example, the input events A include a beginning flag (B1) for T1, three events for T1, an end flag for T1 (E1), a beginning flag for T2 (B2), four events for T2, an end flag for T2 (E2), a beginning flag for T3 (B3), one event for T3, and an end flag for T3 (E3). As shown at box 545, the input events A also include a duplicate beginning flag for T2 (B2). For example, as illustrated by a lightning bolt, the duplicate event may be caused by a service disruption occurring at the end of T2, where a memory of the source component 530 is cleared with respect to the metadata associated with previous events received, such as T2E4.

In accordance with the innovative techniques described herein, the source component 530 selectively publishes the input events A to the staging queue 550 (i.e., “staged events B”). Specifically, the source component 530 discards ones of the input events A that are of a transaction begin type (i.e., B1, B2, duplicate B2, and B3), where empty box 549 represents the discarded duplicate B2. The source component 530 also publishes ones of the input events A that are of a modification type (i.e., T1E1, T1E2, T1E3, T2E1, T2E2, T2E3, T2E4, and T3E1). The source component 530 also selectively publishes or discards each remaining change event based on its unique identifier. Specifically, for this example, E1 is published due to its unique identifier matching T1E3 and E3 is published due to its unique identifier matching T3E1. For this example, however, as shown at box 551, the source component 530 will refrain from publishing the E2 of box 547 due to the loss of memory caused by the service disruption discussed above. Specifically, because the source component 530 will determine that E2 is not a begin type event (at decision block 424 of FIG. 4), determine that E2 is not a mod type event (at decision block 428 of FIG. 4), and ignorantly determine that E2 is a first event for a transaction (at decision block 432 of FIG. 4) due to the memory loss (of the unique identifier associated with T2E4, for example), the source component 530 will discard E2. Thus, it will be appreciated that the staged events B do not include an end boundary for T2.

In accordance with the innovative techniques described herein, the sink component 570 selectively generates boundaries for the staged events B, where the set of selectively published change events along with their selectively generated boundaries is shown in Row “C” and may be referred to as “bounded events C.” Specifically, the sink component 570 generates an end boundary for ones of the staged events B that are of a transaction end type (i.e., E1 and E3). The sink component 570 also publishes ones of the non-boundary events (i.e., T1E2, T1E3, T2E2, T2E3, and T2E4) of the staged events B based on determining that their unique identifier is not the same as the most recently processed change event. For each remaining staged event B (i.e., T1E1, T2E1, and T3E1), the sink component 570 first determines whether an end event for the previous transaction has already been published and selectively generates boundaries based on the determination. For this example, S1 and S2 are generated and published prior to publishing T1E1 and T2E1, respectively, for the same reasons as described with respect to FIG. 5A. When processing T3E1, upon determining that the unique identifier has changed from the previous event, the sink component 570 will verify whether an end event was published for the previous transaction (T2). Because E2 was discarded at the staging queue 550, the sink component 570 will determine that no event has been published for T2. Thus, the sink component 570 will generate E2 (at box 553) for T2 and S3 for T3, as described with respect to decision block 472 of FIG. 4. Accordingly, any adverse effects that may have otherwise been caused downstream by an apparent open transaction are prevented.

Thereafter, the bounded events C may be output as a bounded list of finalized transactions, such as to a data repository (e.g., the data repository 240 of FIG. 2).

FIG. 5E shows an illustrative example 500E for resolving open transactions, according to some implementations. The associated operations may be performed by a computing system, such as the computing system 100 described with respect to FIG. 1. The illustrative example 500B shows the same source component 530, staging queue 550, sink component 570, and target queue 590 described above.

The illustrative example 500E begins with the source component 530 obtaining input events A. For this example, the input events A include a beginning flag (B1) for T1, three events for T1, an end flag for T1 (E1), a beginning flag for T2 (B2), four events for T2, an end flag for T2 (E2), a beginning flag for T3 (B3), one event for T3, and an end flag for T3 (E3). As shown at box 561, the input events A also include a duplicate beginning flag for T3 (B3). For example, as illustrated by a lightning bolt, the duplicate event may be caused by a service disruption occurring at the end of T3, where a memory of the source component 530 is cleared with respect to the metadata associated with previous events received, such as T3E1.

In accordance with the innovative techniques described herein, the source component 530 selectively publishes the input events A to the staging queue 550 (i.e., “staged events B”). Specifically, the source component 530 discards ones of the input events A that are of a transaction begin type (i.e., B1, B2, B3, and duplicate B3), where empty box 563 represents the discarded duplicate B3. The source component 530 also publishes ones of the input events A that are of a modification type (i.e., T1E1, T1E2, T1E3, T2E1, T2E2, T2E3, T2E4, and T3E1). The source component 530 also selectively publishes or discards each remaining change event based on its unique identifier. Specifically, for this example, E1 is published due to its unique identifier matching T1E3 and E2 is published due to its unique identifier matching T2E4. For this example, however, as shown at box 565, the source component 530 will refrain from publishing E3 due to the loss of memory caused by the service disruption discussed above. Specifically, because the source component 530 will determine that E3 is not a begin type event (at decision block 424 of FIG. 4), determine that E3 is not a mod type event (at decision block 428 of FIG. 4), and ignorantly determine that E3 is a first event for a transaction (at decision block 432 of FIG. 4) due to the memory loss (of the unique identifier associated with T3E1, for example), the source component 530 will discard E3. Thus, it will be appreciated that the staged events B do not include an end boundary for T3.

In accordance with the innovative techniques described herein, the sink component 570 selectively generates boundaries for the staged events B, where the set of selectively published change events along with their selectively generated boundaries is shown in Row “C” and may be referred to as “bounded events C.” Specifically, the sink component 570 generates an end boundary for ones of the staged events B that are of a transaction end type (i.e., E1 and E2). The sink component 570 also publishes ones of the non-boundary events (i.e., T1E2, T1E3, T2E2, T2E3, and T2E4) of the staged events B based on determining that their unique identifier is not the same as the most recently processed change event. For each remaining staged event B (i.e., T1E1, T2E1, and T3E1), the sink component 570 first determines whether an end event for the previous transaction has already been published and selectively generates boundaries based on the determination. For this example, S1, S2, and S3 are generated and published prior to publishing T1E1, T2E1, and T3E1, respectively, for the same reasons as described with respect to FIG. 5A.

As represented by empty box 567, for this example, rather than publishing duplicate events, the sink component 570 will wait until a first event for a next transaction (e.g., T4) arrives, at which point, the sink component 570 will generate an end boundary for T3 for the same reasons as discussed with respect to block 474 of FIG. 4.

Thereafter, the bounded events C may be output as a bounded list of finalized transactions, such as to a data repository (e.g., the data repository 240 of FIG. 2).

FIG. 5F shows an illustrative example 500F for resolving open transactions, according to some implementations. The associated operations may be performed by a computing system, such as the computing system 100 described with respect to FIG. 1. The illustrative example 500B shows the same source component 530, staging queue 550, sink component 570, and target queue 590 described above.

The illustrative example 500F begins with the source component 530 obtaining input events A. For this example, the input events A include a beginning flag (B1) for T1, three events for T1, an end flag for T1 (E1), a beginning flag for T2 (B2), four events for T2, an end flag for T2 (E2), a beginning flag for T3 (B3), one event for T3, and an end flag for T3 (E3).

In accordance with the innovative techniques described herein, the source component 530 selectively publishes the input events A to the staging queue 550 (i.e., “staged events B”). Specifically, the source component 530 discards ones of the input events A that are of a transaction begin type (i.e., B1, B2, and B3), publishes ones of the input events A that are of a modification type (i.e., T1E1, T1E2, T1E3, T2E1, T2E2, T2E3, T2E4, and T3E1), and publishes E1 (due to its unique identifier matching T1E3), E2 (due to its unique identifier matching T2E4), and E3 (due to its unique identifier matching T3E1).

In accordance with the innovative techniques described herein, the sink component 570 selectively generates boundaries for the staged events B, where the set of selectively published change events along with their selectively generated boundaries is shown in Row “C” and may be referred to as “bounded events C.” Specifically, the sink component 570 generates an end boundary for ones of the staged events B that are of a transaction end type (i.e., E1, E2, and E3), publishes ones of the non-boundary events (i.e., T1E2, T1E3, T2E2, T2E3, and T2E4) of the staged events B based on determining that their unique identifier is not the same as the most recently processed change event, and then generates and publishes S1, S2, and S3 prior to publishing T1E1, T2E1, and T3E1, respectively, for the same reasons as described with respect to FIG. 5A.

For this example, however, as shown at boxes 575, 577, and 579, and as indicated by a lightning bolt, the sink component 570 may experience a service disruption during the processing of T2 (e.g., after box 579). In some implementations, upon recovering from the service disruption, the sink component 570 may be configured to resume processing the current transaction (T2) from its beginning (i.e., starting back with T2E1). Accordingly, for this example, the S2 published at box 575, the T2E1 published at box 577, and the T2E2 published at box 579 may become duplicate events. In such instances, an additional component (e.g., of the transaction adapter 220 of FIG. 2) may detect and remove said duplicate events. It will be appreciated that, despite the service disruption at the sink component 570, upon the detection and removal of the duplicate events, the bounded events C will enable the prevention of any adverse effects that may have otherwise been caused downstream by an apparent open transaction.

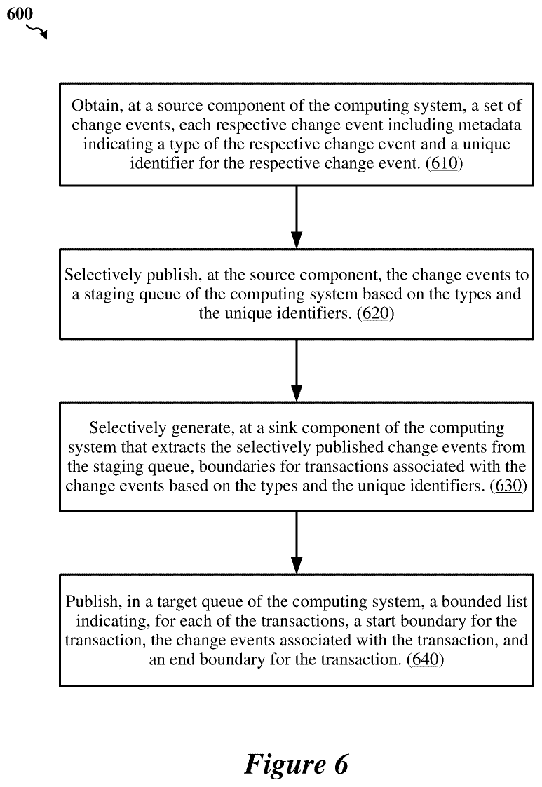

FIG. 6 shows an illustrative flowchart 600 depicting an example operation for resolving open transactions, according to some implementations, and may be performed by one or more processors of a computing system, such as the computing system 100 described with respect to FIG. 1. For example, at block 610, the computing system 100 obtains, at a source component of the computing system, a set of change events, each respective change event including metadata indicating a type of the respective change event and a unique identifier for the respective change event. At block 620, the computing system 100 selectively publishes, at the source component, the change events to a staging queue of the computing system based on the types and the unique identifiers. At block 630, the computing system 100 selectively generates, at a sink component of the computing system that extracts the selectively published change events from the staging queue, boundaries for transactions associated with the change events based on the types and the unique identifiers. At block 640, the computing system 100 publishes, in a target queue of the computing system, a bounded list indicating, for each of the transactions, a start boundary for the transaction, the change events associated with the transaction, and an end boundary for the transaction.

As used herein, a phrase referring to “at least one of” a list of items refers to any combination of those items, including single members. As an example, “at least one of: a, b, or c” is intended to cover: a, b, c, a-b, a-c, b-c, and a-b-c.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The various illustrative logics, logical blocks, modules, circuits, and algorithm processes described in connection with the implementations disclosed herein may be implemented as electronic hardware, computer software, or combinations of both. The interchangeability of hardware and software has been described, in terms of functionality, and illustrated in the various illustrative components, blocks, modules, circuits and processes described above. Whether such functionality is implemented in hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

What is claimed is:

1. A method for resolving open transactions, the method performed by one or more processors of a computing system and comprising:
obtaining, at a source component of the computing system, a set of change events, each respective change event including metadata indicating a type of the respective change event and a unique identifier for the respective change event;
selectively publishing, at the source component, the change events to a staging queue of the computing system based on the types and the unique identifiers;
selectively generating, at a sink component of the computing system that extracts the selectively published change events from the staging queue, boundaries for transactions associated with the change events based on the types and the unique identifiers; and
publishing, in a target queue of the computing system, a bounded list indicating, for each of the transactions, a start boundary for the transaction, the change events associated with the transaction, and an end boundary for the transaction.

2. The method of claim 1, wherein selectively publishing the change events to the staging queue includes:
selectively discarding, at the source component, each respective change event based on whether the type of the respective change event is a transaction begin type.

3. The method of claim 2, wherein selectively discarding each respective change event includes:
discarding the respective change event responsive to determining that the type of the respective change event is a transaction begin type; and
advancing the respective change event for further processing by the source component responsive to determining that the type of the respective change event is not a transaction begin type.

4. The method of claim 3, wherein selectively publishing the change events to the staging queue further includes:
selectively publishing, at the source component, each respective change event to the staging queue based on whether the type of the respective change event is a modification type.

5. The method of claim 4, wherein selectively publishing each respective change event includes:
publishing the respective change event to the staging queue responsive to determining that the type of the respective change event is a modification type; and
advancing the respective change event for further processing by the source component responsive to determining that the type of the respective change event is not a modification type.

6. The method of claim 5, wherein selectively publishing the change events to the staging queue further includes:
selectively publishing or discarding, at the source component, each remaining change event based on its unique identifier.

7. The method of claim 6, wherein selectively publishing or discarding each remaining change event includes:
publishing the remaining change event to the staging queue responsive to determining that the unique identifier for the remaining change event has been published to the staging queue in connection with at least one other change event; and
discarding the remaining change event responsive to determining that the unique identifier for the remaining change event has not been published to the staging queue in connection with any other change event.

8. The method of claim 7, wherein publishing the remaining change event to the staging queue includes:
determining that a type of the remaining change event is a transaction end type;
identifying a transaction associated with the at least one other change event; and
publishing the remaining change event as a final event for the identified transaction.

9. The method of claim 8, wherein the remaining change event is published as the final event for the identified transaction responsive to determining that a first event for a next transaction is about to be published to the staging queue.

10. The method of claim 1, wherein selectively generating the boundaries includes:
selectively generating, at the sink component, an end boundary for a transaction associated with the extracted change event based on whether the type of the extracted change event is a transaction end type.

11. The method of claim 10, wherein selectively generating the end boundary includes:
generating the end boundary responsive to determining that the type of the extracted change event is a transaction end type, wherein the end boundary is published to the target queue in connection with the associated transaction; and
advancing the extracted change event for further processing by the sink component responsive to determining that the type of the extracted change event is not a transaction end type.

12. The method of claim 11, further comprising, for each remaining change event:
retrieving the unique identifier for a most recently processed change event; and
selectively publishing, at the sink component, the remaining change event to the target queue based on a comparison of the unique identifier for the remaining change event and the unique identifier for the most recently processed change event.

13. The method of claim 12, wherein selectively publishing the remaining change events includes:
publishing the remaining change event to the target queue responsive to determining that the unique identifier for the remaining change event is the same as the unique identifier for the most recently processed change event, wherein the remaining change event is published to the target queue in connection with a same transaction as the most recently processed change event; and
advancing the remaining change event for further processing by the sink component responsive to determining that the unique identifier for the remaining change event is different than the unique identifier for the most recently processed change event.

14. The method of claim 13, wherein selectively generating the boundaries further includes:
selectively generating, at the sink component, an end boundary for a most recently processed transaction based on a presence of an existing end boundary for the most recently processed transaction.

15. The method of claim 14, wherein selectively generating the end boundary for the most recently processed transaction includes:
refraining from generating the end boundary for the most recently processed transaction responsive to detecting a presence of an existing end boundary for the most recently processed transaction; and
generating the end boundary for the most recently processed transaction responsive to not detecting a presence of an existing end boundary for the most recently processed transaction, wherein the end boundary is published to the target queue in connection with the most recently processed transaction.

16. The method of claim 15, wherein selectively generating the boundaries further includes, for each extracted change event:
generating a start boundary for the transaction associated with the extracted change event responsive to generating or refraining from generating the end boundary for the most recently processed transaction, wherein the start boundary is published to the target queue in connection with the associated transaction.

17. The method of claim 1, wherein obtaining the set of change events includes:
extracting the set of change events from a source database, wherein the source database is one of a plurality of source databases managed by a database management system (DBMS) serving a plurality of source applications, wherein the set of change events is extracted from a change log generated by the DBMS based on changes made to tables used by the plurality of source applications, and wherein each of the transactions corresponds to a subset of the changes made to the tables distributed across the plurality of source applications.

18. The method of claim 1, wherein:
the source component publishes the change events into a plurality of partitions of the staging queue based on the unique identifiers, the change events associated with a same transaction partitioned into a same partition;
the sink component is a distributed sink component including a plurality of sink component instances that parallelly process the change events from the partitions of the staging queue based on a partition map;
the bounded list includes partition indicators indicating, for each respective transaction, the one of the partitions to which the respective transaction is assigned; and
the distributed sink component publishes the bounded list into partitions of the target queue corresponding to the partitions of the staging queue based on the partition indicators.

19. The method of claim 1, further comprising:
providing, by the target queue, bounded transactions to a data repository based on the bounded list, wherein the data repository is a data warehouse including a data mart coupled to one or more reporting applications.

20. A computing system for resolving open transactions, the computing system comprising:
one or more processors; and
at least one memory coupled to the one or more processors and storing instructions that, when executed by the one or more processors, cause the computing system to perform operations including:
obtaining, at a source component of the computing system, a set of change events, each respective change event including metadata indicating a type of the respective change event and a unique identifier for the respective change event;
selectively publishing, at the source component, the change events to a staging queue of the computing system based on the types and the unique identifiers;
selectively generating, at a sink component of the computing system that extracts the selectively published change events from the staging queue, boundaries for transactions associated with the change events based on the types and the unique identifiers; and
publishing, in a target queue of the computing system, a bounded list indicating, for each of the transactions, a start boundary for the transaction, the change events associated with the transaction, and an end boundary for the transaction.
